(19) United States
(12) Patent Application Publication
(10) Pub. No.: US 2017/0328568 A1
(43) Pub. Date: Nov. 16, 2017

(54) FUEL LANCE WITH MEANS FOR INTERACTING WITH A FLOW OF AIR AND IMPROVE BREAKAGE OF AN EJECTED LIQUID JET OF FUEL

(71) Applicant: Siemens Aktiengesellschaft, München (DE)

(72) Inventor: Juan Enrique Portillo Bilbao, Oviedo, FL (US)

(21) Appl. No.: 15/525,464

(22) PCT Filed: Nov. 26, 2014
(86) PCT No.: PCT/US2014/067620

§ 371 Date: May 9, 2017

(51) Int. Cl. F23R 3/28; F23D 11/38; F02C 7/22

(52) U.S. Cl. CPC F23R 3/286; F23D 11/38; F02C 7/222; F23D 2900/11001

(57) ABSTRACT

Apparatus and method for a combustion turbine engine are provided. The apparatus may include a fuel-injecting lance (12) to convey a liquid fuel to a downstream end (16) of the lance. At least one jet in cross-flow injector (18) may be disposed at the downstream end of the lance, and includes an ejection orifice (20) responsive to eject a liquid jet (22) of the fuel. A plurality of surface irregularities (28, 29, 30, 50, 52, 54) is disposed at least on a portion of a wall (32) of the fuel-injecting lance exposed to the flow of air and proximate to the ejection orifice (20). The plurality of surface irregularities may be arranged to interact (e.g., turbulent interaction) with the flow of air to promote breakage of the ejected liquid jet of fuel compared to an injector lacking such surface irregularities.

### BACKGROUND

### 1. Field

Disclosed embodiments are generally related to apparatus and method for a combustion turbine engine, such as a hybrid fuel turbine, and, more particularly, to a fuel-injecting lance with means, such as may comprise surface irregularities, for interacting with a flow of air and improve breakage of an ejected liquid jet of fuel.

### 2. Description of the Related Art

Combustion turbine engines, such as gas turbines, hybrid fuel turbines, typically use combustors that may include a plurality of main burners disposed around a centrally disposed pilot burner. Injection of a liquid fuel across an incoming air flow is commonly used in hybrid fuel turbines. Liquid jet in cross-flow (JICF) has gained interest as a candidate for spray formation potentially helpful to reducing emissions, such as reduction of NOx emissions. Since the quality of spray formation (e.g., quality of atomization) can directly influence the combustion efficiency of the turbine and the level of emissions produced by the turbine, it is desirable to provide improvements, such as in the non-limiting context of liquid JICF injectors so as to, for example, reliably and cost-effectively produce a substantially lean, homogenous mixture of fuel and air.

### BRIEF DESCRIPTION OF THE DRAWINGS

FIG. 1 is an isometric view of one non-limiting example of a combustor apparatus embodying aspects of the present invention, as may be used in a combustion turbine engine.

FIG. 2 is a side view of a downstream end of one non-limiting embodiment of a fuel-injecting lance including a jet in cross-flow injector comprising surface irregularities arranged to interact with a flow of air to be mixed with the fuel and effective to promote breakage of the ejected liquid jet of fuel compared to a lance lacking such surface irregularities.

FIGS. 3-6 are respective schematics illustrating various non-limiting embodiments of surfaces irregularities that may be used to implement aspects of the present invention.

FIGS. 7 and 8 may be used to conceptualize example drawbacks associated with fuel-injecting lances not including surface irregularities, and thus lacking structural features in accordance with aspects of the present invention.

### DETAILED DESCRIPTION

The inventor of the present invention has recognized certain issues that can arise in the context of some prior art combustors, as may be used in turbine engines, such as hybrid fuel turbines. Presently, in one non-limiting application as may involve Lean Premixed Prevaporized (LPP) combustion, a liquid fuel, such as may comprise oil, may be mixed with a flow of air via jet in cross-flow (JICF). However, in known combustor designs, the structure of the fuel injector comprises a blunt body (e.g., lacking outer surface irregularities) so that a relatively large region of flow separation is formed downstream of the liquid fuel injection point. This causes a delay in the breakup of the fuel exiting the injector and results in a fuel spray comprising relatively large drop diameters. Larger drop diameter in the fuel spray can lead to higher levels of emissions, such as NOx emissions, since larger drops are not conducive to efficient mixing.

The inventor of the present invention has innovatively recognized that the region of flow separation downstream of the liquid fuel injection point can be substantially reduced if, for example, an outer surface of a wall defining a tip of the lance is constructed with means for interacting with a flow of air to be mixed with the fuel, such as surface irregularities, that may comprise without limitation, dimples, protrusions, grooves, combinations of different types of surface irregularities, etc.

The inclusion of such surface irregularities is conducive to forming a strong turbulent flow near the injection region, which results in a reduced delay in the flow separation. Based on these features, the jet of fuel interacts with the cross flow of air closer to the ejection point of the injector and results in a fuel spray comprising relatively smaller diameter droplets. It will be appreciated that in certain applications, if one opted to maintain a given size of droplet diameter in lieu of smaller diameter of droplets, then a concomitant decrease in the operating pressure of the injector would result in beneficial operating conditions for the involved components.

In view of the foregoing considerations, the inventor of the present invention proposes an apparatus and methodology effective to promote strong shear between the liquid jet of fuel and the incoming flow of air and thus effective to promote relatively fine atomization comprising relatively smaller droplets and resulting in improved mixing of air and liquid fuel in a reliable and cost-effective manner, and thus effective to improve the combustion efficiency of the turbine and reduce the level of emissions produced by the turbine. Moreover, the resulting improved mixing of air and liquid fuel may advantageously increase the operational envelope of the engine in a similarly reliable and cost-effective manner.

In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

The terms “comprising”, “including”, “having”, and the like, as used in the present application, are intended to be synonymous unless otherwise indicated. Lastly, as used herein, the phrases “configured to” or “arranged to” embrace the concept that the feature preceding the phrases “configured to” or “arranged to” is intentionally and specifically designed or made to act or function in a specific way and should not be construed to mean that the feature just has a capability or suitability to act or function in the specified way, unless so indicated.

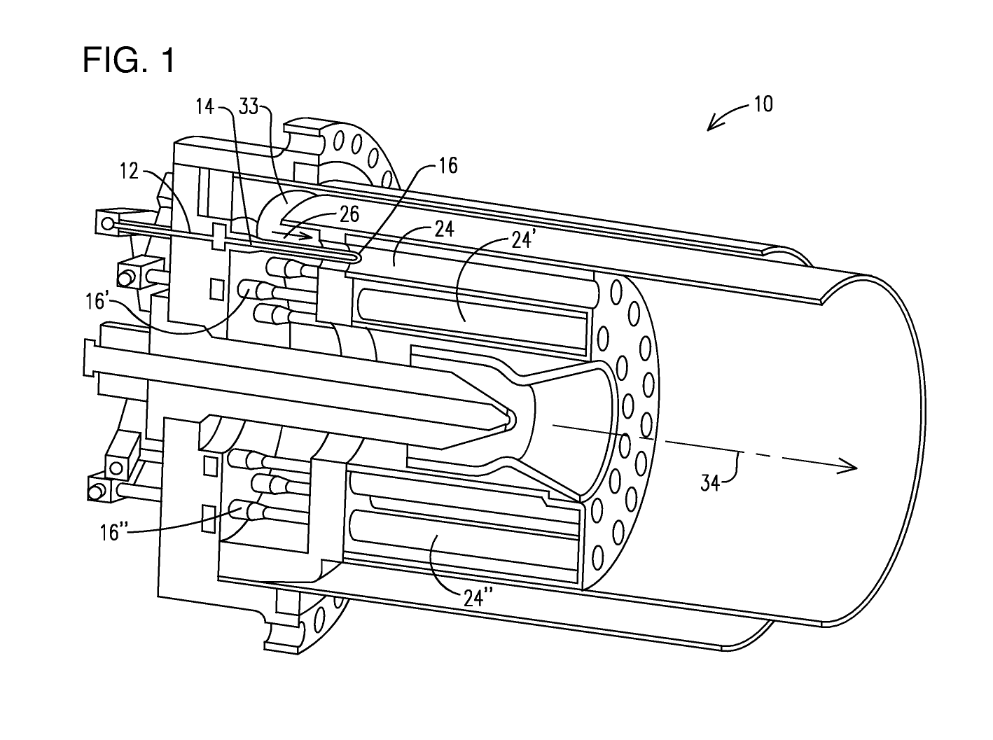

FIG. 1 is an isometric view of a combustor apparatus 10 embodying aspects of the present invention, as may be used in a combustion turbine engine, such as a hybrid fuel turbine, as may use gas fuel and/or liquid fuel. In one non-limiting embodiment, apparatus 10 includes a fuel-injecting lance 12 including a fuel circuit 14 to convey a liquid fuel to a downstream end 16 of lance 12.

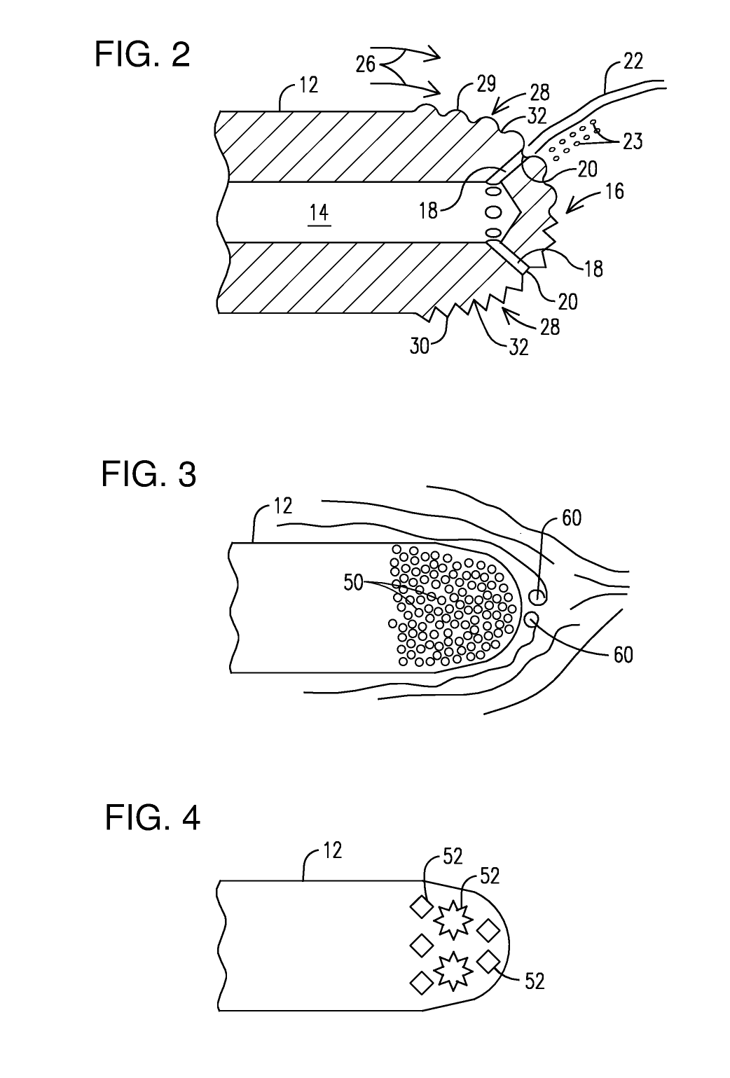

As may be appreciated in FIG. 2, at least one injector 18, such as a jet in cross-flow injector (JICF), an angled jet in cross-flow injector, a simplex injector, an impinging jet injector or other suitable injector, may be disposed at downstream end 16 of fuel-injecting lance 12. The at least one jet in cross-flow injector 18 includes an ejection orifice 20 responsive to fuel circuit 14 to eject a liquid jet 22 of the fuel. For simplicity of illustration, just the liquid jet of a single jet in cross-flow injector 18 is illustrated in FIG. 2. It will be appreciated that in a practical embodiment a number of injectors may be circumferentially arranged in one or more rows at the downstream end of the lance. As may be appreciated in FIG. 1, a pre-mixing passage or pre-mixing tube 24 has an upstream inlet arranged to receive the flow of air (schematically represented in by arrows 26) to be mixed with the fuel.

In accordance with aspects of the present invention, a means for interacting (e.g., turbulatingly affecting the flow of air) with the flow of air to be mixed with the fuel is provided. In one non-limiting embodiment, such means for interacting may comprise a plurality of surface irregularities 28 (FIG. 2) disposed at least on a portion (e.g., a tip portion) of an outer wall 32 of fuel-injecting lance 12 exposed to the flow of air and proximate to ejection orifice 20, e.g., upstream and downstream relative to ejection orifice 20. The plurality of surface irregularities 28 may be arranged to interact (e.g., turbulent interaction) with the flow of air and the interaction with the flow of air is effective to promote breakage of the ejected liquid jet 22 of fuel compared to a fuel-injecting lance lacking such surface irregularities. This may be conducive to a reduced region 60 of flow separation (FIG. 3) downstream of the liquid fuel injection point compared to a larger region 70 of flow separation in a prior art fuel-injecting lance 72 lacking such surface irregularities, as may be schematically appreciated in FIG. 7. This in turn is conducive to the formation of relatively smaller diameter droplets 23 (FIG. 2) compared to the diameter of larger drops 25 formed in a prior art fuel-injecting lance 27 lacking such surface irregularities, as may be schematically appreciated in FIG. 8.

In one non-limiting embodiment, an annular flow-turning conduit 33 (FIG. 1) may be arranged to direct the flow of air into pre-mixing passage 24 and into further pre-mixing passages, such as pre-mixing passages 24′, 24″, circumferentially arranged about the longitudinal axis 34 of combustor apparatus 10. Each of the further pre-mixing passages 24′, 24″ comprises a respective fuel-injecting lance 16′, 16″, as disclosed above.

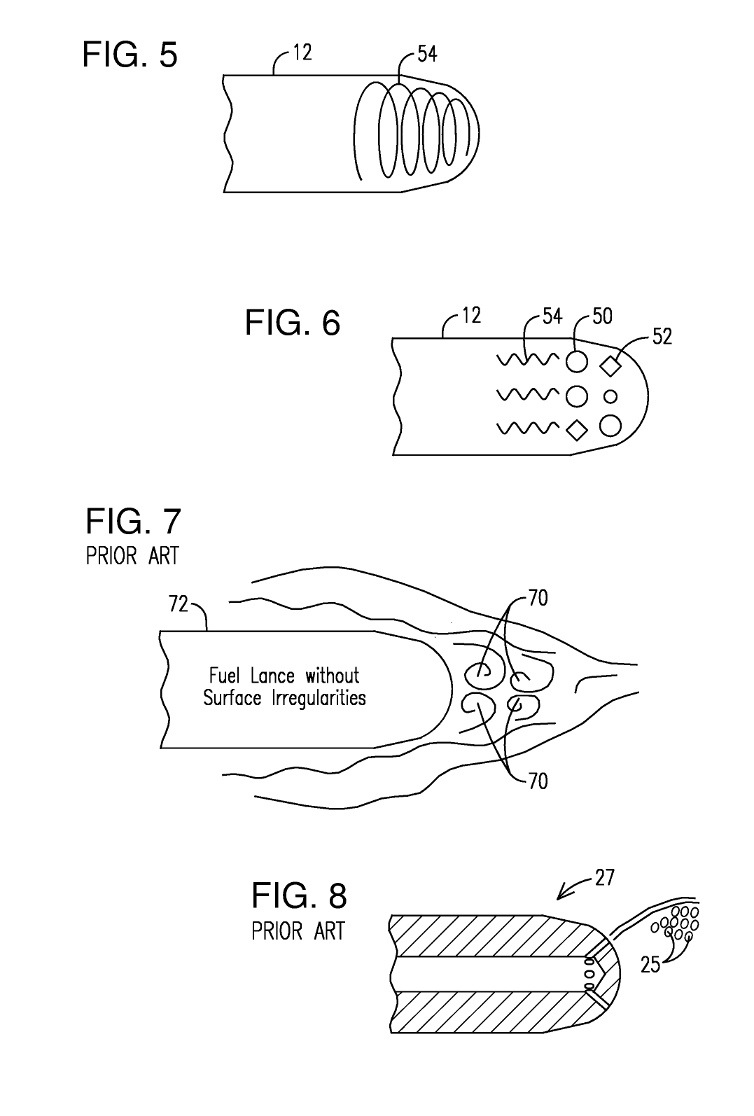

It will be appreciated that the plurality of surface irregularities 28 may be implemented by way of various structural modalities, such as protuberances 29 without corners (e.g., undulated, rounded, oval, etc), protuberances with corners 30, (e.g., polygonal shape, star-shaped, etc.), both as schematically represented in FIG. 2; dimples 50 without corners (e.g., rounded, oval, etc.), as schematically represented in FIG. 3; dimples 52 with corners (e.g., polygonal shape, star-shaped, etc.), as schematically represented in FIG. 4; one or more grooves 54 that in one-non-limiting embodiment may be arranged as a helix, as schematically represented in FIG. 5; and, in further alternative embodiment, combinations of at least two different types of such surface irregularities, e.g., protuberances, dimples, grooves, could be used, as schematically illustrated in FIG. 6. It will be appreciated that the number, patterns comprising different cross-sectional shapes and/or sizes of the plurality of surface irregularities may be appropriately tailored based on the needs of a given application.

In one non-limiting embodiment, the plurality of dimples and/or the plurality of protuberances may comprise a respective diameter in a range from about 20% to about 200% of the diameter of the ejection orifice. In another non-limiting embodiment, the plurality of grooves may comprise a respective width in a range from about 20% to about 200% of the diameter of the ejection orifice.

Without limiting aspects of the present invention to any particular principle of operation, the interacting of the plurality of surface irregularities with the flow of air is effective to reduce a delay in the breakage of the ejected jet of liquid fuel, which otherwise would result in larger drop diameters, as discussed in the context of FIG. 8. Aspects of the present invention may be implemented in various types of combustors, such as in a diluted oxygen combustion (DOC) type of combustor and in an effusion type of combustor.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1-22. (canceled)

23. Apparatus for a combustion turbine engine, comprising:
a fuel-injecting lance comprising a fuel circuit to convey a liquid fuel to a downstream end of the lance;
at least one injector disposed at the downstream end of the lance, the at least one injector having an ejection orifice responsive to the fuel circuit to eject a liquid jet of the fuel;
a pre-mixing passage having an upstream inlet arranged to receive a flow of air to be mixed with the fuel; and
a plurality of surface irregularities disposed at least on a portion of a wall of the fuel-injecting lance exposed to the flow of air and proximate to the ejection orifice, the plurality of surface irregularities arranged to interact with the flow of air, the interaction with the flow of air effective to promote breakage of the ejected liquid jet of fuel compared to a lance lacking said surface irregularities, wherein the plurality of surface irregularities comprises a plurality of dimples.

24. The apparatus of claim 23, wherein the at least one injector comprises a jet in cross-flow injector.

25. The apparatus of claim 23, further comprising an annular flow-turning conduit arranged to direct the flow of air into the pre-mixing passage and into further pre-mixing passages circumferentially arranged about a longitudinal axis of the apparatus.

26. The apparatus of claim 25, wherein each of the further pre-mixing passages comprises a respective fuel-injecting lance.

27. The apparatus of claim 23, wherein the plurality of surface irregularities further comprises a plurality of grooves.

28. The apparatus of claim 23, wherein the plurality of surface irregularities comprises a combination of at least two different types of surface irregularities selected from the group consisting of dimples, protuberances and grooves.

29. The apparatus claim 23, wherein the plurality of dimples is selected from the group consisting of dimples with corners, dimples without corners, and a combination of dimples with corners and dimples without corners.

30. The apparatus of claim 27, wherein the plurality of grooves comprises a respective width in a range from about 20% to about 200% of the diameter of the ejection orifice.

31. The apparatus of claim 28, wherein the plurality of dimples and/or the plurality of protuberances comprises different cross-sectional shapes and/or sizes.

32. The apparatus of claim 27, wherein at least one groove of the plurality of grooves defines a helix on the portion of the wall of the fuel-injecting lance.

33. Apparatus for a combustion turbine engine, comprising:
a fuel-injecting lance comprising a fuel circuit to convey a liquid fuel to a downstream end of the lance;
at least one injector disposed at the downstream end of the lance, the at least one injector having an ejection orifice responsive to the fuel circuit to eject a liquid jet of the fuel;
a pre-mixing passage having an upstream inlet arranged to receive a flow of air to be mixed with the fuel; and
a plurality of surface irregularities disposed at least on a portion of a wall of the fuel-injecting lance exposed to the flow of air and proximate to the ejection orifice, the plurality of surface irregularities arranged to interact with the flow of air, the interaction with the flow of air effective to promote breakage of the ejected liquid jet of fuel compared to a lance lacking said surface irregularities, wherein the plurality of surface irregularities comprises a plurality of grooves.

34. The apparatus of claim 33, wherein the at least one injector comprises a jet in cross-flow injector.

35. The apparatus of claim 33, further comprising an annular flow-turning conduit arranged to direct the flow of air into the pre-mixing passage and into further pre-mixing passages circumferentially arranged about a longitudinal axis of the apparatus.

36. The apparatus of claim 35, wherein each of the further pre-mixing passages comprises a respective fuel-injecting lance.

37. The apparatus of claim 33, wherein the plurality of surface irregularities further comprises a plurality of dimples.

38. The apparatus of claim 33, wherein the plurality of surface irregularities comprises a combination of at least two different types of surface irregularities selected from the group consisting of dimples, protuberances and grooves.

39. The apparatus claim 33, wherein the plurality of dimples is selected from the group consisting of dimples with corners, dimples without corners, and a combination of dimples with corners and dimples without corners.

40. The apparatus of claim 33, wherein the plurality of grooves comprises a respective width in a range from about 20% to about 200% of the diameter of the ejection orifice.

41. The apparatus of claim 39, wherein the plurality of dimples and/or the plurality of protuberances comprises different cross-sectional shapes and/or sizes.

42. The apparatus of claim 33, wherein at least one groove of the plurality of groves defines a helix on the portion of the wall of the fuel-injecting lance.
